(19) United States
(12) Patent Application Publication
(10) Pub. No.: US 2008/0139385 A1
(43) Pub. Date: Jun. 12, 2008

(54) Thermally Sensitive Recording Medium

(76) Inventors: Akihito Ogino, Tokyo (JP); Seiki Yoneshige, Tokyo (JP); Junpei Natsui, Tokyo (JP); Jun Makihara, Tokyo (JP); Naoki Negishi, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 11/795,354

(22) PCT Filed: Dec. 6, 2005
(86) PCT No.: PCT/JP05/22736

§ 371 Date: Jul. 13, 2007

(30) Foreign Application Priority Data
Jan. 13, 2005 (JP) 2005-006782

(51) Int. Cl. B41M 5/337

(52) U.S. Cl. 503/220

(57) ABSTRACT

A thermally sensitive recording medium laminating a protecting layer on a thermally sensitive recording layer containing a colorless or pale colored electron donating leuco dye and electron accepting color developing agent, said thermally sensitive recording layer is formed on a substrate, and said protecting layer is comprising a resin that contains a carboxyl group, epichlorohydrin resin and modified polyamine/amide resin, and said thermally sensitive recording medium exhibits sufficient resistance against water such as rain or humidity, further excellent in printing run-ability (head debris and sticking) and sensitivity.

### FIELD OF THE INVENTION

The present invention relates to a thermally sensitive recording medium which is excellent in water resistance, printing run-ability (head debris, sticking) and sensitivity.

### BACKGROUND OF THE INVENTION

In general, a thermally sensitive recording medium is obtained by coating a coating liquid on a substrate such as paper, synthetic paper, film or plastic, wherein said coating liquid is prepared by grinding and dispersing respectively a colorless or pale colored electron donating leuco dye and an electron accepting color developing agent such as phenolic compound to fine particles, then mixing them together, adding binder, filler, sensitizer, slipping agent and other additives. The obtained thermally sensitive recording medium develops color by instant chemical reaction by heating using a thermal head, a hot stamp, a thermal pen or by heating by laser light and a recorded image can be obtained. A thermally sensitive recording medium is widely used in a terminal printer of facsimile or computer, an automatic ticket vending machine or a recorder for measuring instrument, and along with the diversification of uses, high level image stability and stability of blanc part are becoming to be required to the thermally sensitive recording medium.

However, since an electron donating leuco dye and an electron accepting color developing agent contained in a thermally sensitive recording layer can be easily dissolved in many kinds of solvent, the thermally sensitive recording medium has a problem that blanc part develops color easily when contacted with water ink, oil ink or adhesive and a problem that, when a chemical such as plasticizer is adhered to the developed recorded image, the image is discolored. For the purpose to dissolve said problems, a technique to form a protecting layer which is mainly composed of a pigment and resin on a thermally sensitive recording layer is disclosed in Patent Document 1 and Patent Document 2.

Further, the use of a thermally sensitive recording medium is expanding to various kinds of tickets, a receipt, a label, use for an auto talking machine of Bank, use for inspection of a gas or electric meter or a note for betting-ticket for horse racing or cycle racing, therefore, very severe characteristics, which are not required up to the present, are becoming to be required to a thermally sensitive recording medium. In cases of these uses, since the outdoor use is becoming more often, characteristics and properties of a protecting layer that can endure more severe atmosphere, such as rain or very high humid, direct sunshine or inside of car at summer season, are becoming more necessary compared with conventional use.

As the components that compose a protecting layer, for example, water soluble polymers such as polyvinyl alcohol or starch are used as main components. For the purpose to provide water resistance to these components, the technique to use a crosslinking agent such as glyoxal is disclosed in Patent Document 3 and Patent Document 4, but the effect is not sufficient yet. Especially, in Patent Document 4, carboxy modified polyvinyl alcohol is used as a binder for protecting layer, epichlorohydrin and glyoxal are used as a crosslinking agent, and this technique is to provide water resistance to the carboxy modified polyvinyl alcohol by carrying out crosslinking reaction of epichlorohydrin with carboxyl group of the carboxy modified polyvinyl alcohol and by carrying out crosslinking reacting of glyoxal with hydroxyl group of the carboxy modified polyvinyl alcohol and. However, since crosslinking reaction rate is too slow, water resistance is not accomplished instantly and it is difficult to display sufficient effect just after coating and drying process. Accordingly, in a case to use epichlorohydrin as a crosslinking agent, long time heat treatment, that is, curing process is necessary, and problems of background coloring or workability, namely, product can not be obtained immediately after production are caused. Further, the water resistance under severe condition is not sufficient because the crosslinked part is easily hydrolyzed.

Further, in Patent Document 5, a technique to provide water resistance by using hydrophobic resin emulsion such as acrylic emulsion is disclosed, however, since heat-resistance property of acrylic emulsion is not sufficient, printing run-ability such as head debris or sticking is harmed, and there is a problem of workability, that is, desired coating amount can not be obtained because viscosity at high share is low.

Patent Document 1: JP S48-30437 A publication

Patent Document 2: JP S48-31958 A publication

Patent Document 3: JP H8-230324 A publication

Patent Document 9: JP H9-164763 A publication

Patent Document 5: JP H1-196389 A publication

### DISCLOSURE OF THE INVENTION

The object of the present invention is to provide a thermally sensitive recording medium that has sufficient water resistance against water such as rain or humid when used at outdoor, further, is excellent in printing run-ability (head debris, sticking) and sensitivity.

The inventors of the present invention, continued the earnest investigation and found out that the object of the present invention mentioned above can be dissolved by forming a protecting layer using a resin containing carboxylic group as a binder, epichlorohydrin resin and modified polyamine/amide resin as a crosslinking agent to the thermally sensitive recording medium, and accomplished the present invention.

That is, the present invention is a thermally sensitive recording medium having a protecting layer on a thermally sensitive recording layer containing a colorless or pale colored electron donating leuco dye and electron accepting color developing agent, said thermally sensitive recording layer is formed on a substrate, and said protecting layer is comprising a resin that contains a carboxyl group, epichlorohydrin resin and modified polyamine/amide resin. By said thermally sensitive recording medium, the object of the present invention can be dissolved.

### DESCRIPTION OF THE PREFERRED EMBODIMENT

The reason why the present invention can display excellent water resistance compared with the conventional arts can be considered as follows.

In a protecting layer of the thermally sensitive recording medium of the present invention, a carboxyl group of the resin containing carboxyl group and amine or amide part of epichlorohydrin resin, which is a crosslinking agent, causes crosslinking reaction and displays primary water resistance. Then, since hydrophilic part of the modified polyamine/amide resin and crosslinked part which has hydrophilicity attracts each other, this crosslinked part forms a state that is wrapped by setting the hydrophobic groups of the modified polyamine/amide resin outside, that is, the state characterized that the hydrophilic crosslinked part is protected by a hydrophobic group from water, thus the secondary water resistance is displayed. Therefore, stronger water resistance than the conventional art can be obtained.

Especially, in a case when a resin which contains carboxyl group is a carboxy modified polyvinyl alcohol, grounds that high water resistance property is performed can be considered as follows. That is, hydrophilic part of the modified polyamine/amide resin is attracted to a hydroxyl group of the carboxy modified polyvinyl alcohol and forms wrapped state that the carboxy modified polyvinyl alcohol is wrapped by setting the hydrophobic group of the modified polyamine/amide resin outside, further, cationic part of the modified polyamine/amide resin is reacted with a carboxyl group of the carboxy modified polyvinyl alcohol by a kind of a crosslinking reaction.

As mentioned above, by providing higher water resistance effect to a reacted part of resin with a crosslinking agent that are used in a protecting layer, it becomes possible to protect elution of a binder or other components contained in a coated layer by water or humid, and can improve water resistance (resistance against blocking, resistance against wet rubbing).

Further, since the protecting layer of the present invention has three dimensional structure by crosslinking reaction of carboxy modified polyvinylalcohol with epichlorohydrin resin, and modified polyamino/amide resin, which has cationic property, displays dispersion effect to an anionic pigment, it is considered that the protecting layer of the present invention forms more porous layer compared with conventional art. Therefore, since fused product of a low heat-resistance material contained in a coated layer formed by high temperature condition is absorbed by openings in the protecting layer, the thermally sensitive recording medium of the present invention has an excellent printing runability (head debris resistance, sticking resistance).

In the present application, a resin containing carboxyl group, which is used as a binder in a protecting layer, any compound that has a carboxyl group can be used, for example, resin that contains mono-functional acrylic monomer possessing carboxylic group such as methacrylic acid, 2-hydroxyethyl-methacrylate, 2-hydroxypropylmethacrylate, dimethylaminoethyl-methacrylate, tert-butylaminoethylmethacrylate, glycidilmethacrylate or tetrahydrofurifurilmethacrylate, starch oxide, carboxy methyl cellulose, carboxy modified polyvinylalcohol prepared by introducing carboxyl group to polyvinyl alcohol can be mentioned, in particular, it is desirable to use a carboxy modified polyvinylalcohol which is excellent in heat resistance and solvent resistance.

The carboxy modified polyvinylalcohol used in present invention is prepared by introducing carboxyl group to water soluble polymer for the purpose to enhance the reactivity of the water soluble polymer, and can be obtained as a reacted product of polyvinylalcohol with a polyvalent carboxylic acid such as fumaric acid, phthalic anhydride, mellitic anhydride or itaconic anhydride, esterficated product of these compounds, further, as a saponificated product of copolymer composed of vinyl acetate with ethylene unsaturated dicarboxylic acid such as maleic acid, fumaric acid, itaconic acid, crotonic acid, acrylic acid or methacrylic acid. Specifically, for example, a method for preparation disclosed in JP S53-91995 A publication can be mentioned.

Further, the carboxy modified polyvinylalcohol used in present invention is characterized that Hercules viscosity of it is low, that is, at the state that rotating power (share) is loaded, fluidity of it becomes high, and when share is low it becomes easy to be immovable. Therefore, at coating process, a coating liquid spreads smoothly and after coated it solidify in a moment and forms uniform and even coating layer, accordingly, quality of printed image and sensitivity is improved. Furthermore, the carboxy modified polyvinylalcohol is also characterized that water retention is high, it is possible to prevent permeation of a binder to a substrate, and by this effect too, even coating layer can be formed, accordingly quality of printed image and sensitivity is improved.

From the view point that water retention of a coating liquid is high and surface strength of a coating layer is good, polymerization degree of the carboxy modified polyvinylalcohol used in present invention is desirably to be 1500 or more and saponification degree of it is desirably 85% or more.

Further, as a crosslinking agent to be used in the present invention, epichlorohydrin resin and modified polyamino/amide resin are used together with. When these resins are used alone, sufficient water resistance can not be obtained, and a problem such as blocking is caused. Still further, by other conventional crosslinking agent, such as together use of glyoxal and epichlorohydrin resin or modified polyamino/amide resin, sufficient water resistance can not be obtained.

As a specific example of epichlorohydrin resin to be used in the present invention, polyamide epichlorohydrin resin or polyamine epichlorohydrin resin can be mentioned, and these resins can be used alone or can be used together with. And as an amine which exists in main chain, all amines from primary-amine to quaternary amine can be used and is not restricted. Further, cationated degree and molecular weight, from the view point of good water resistance, cationated degree of 5 meq/g·Solid or less (measured at pH7) and molecular weight of 500,000 or less are desirable. As a specific example, Sumirez Resin 675A (product of Sumitomo Chemical), Sumirez Resin 6615 (product of Sumitomo Chemical), WS4002 (product of Seiko PMC), WS4024 (product of Seiko PMC), WS4046 (product of Seiko PMC), WS4010 (product of Seiko PMC) or CP8970 (product of Seiko PMC) can be mentioned.

In the present invention, together use of epichlorohydrin resin and modified polyamino/amide resin is necessary. In general, this modified polyamino/amide resin is called as a printing aptitude improving agent. For example, polyamide urea resin, polyethylene imine resin, polyalkylene polyamine resin and polyalkylene polyamide resin can be mentioned, and as a specific example, Sumirez Resin 302 (product of Sumitomo Chemical), Sumirez Resin 712 (product of Sumitomo Chemical), Sumirez Resin 703 (product of Sumitomo Chemical), Sumirez Resin 636 (product of Sumitomo Chemical), Sumirez Resin SPI-100 (product of Sumitomo Chemical), Sumirez Resin SPI-102A (product of Sumitomo Chemical), Sumirez Resin SPI-106N (product of Sumitomo Chemical), Sumirez Resin SPI-203(50) (product of Sumitomo Chemical), Sumirez Resin SPI-198 (product of Sumitomo Chemical), Printive A-700 (product of Asahi Kasei), Printive A-600 (product of Asahi Kasei), PA6500 (product of Seiko PMC), PA6504 (product of Seiko PMC), PA6634 (product of Seiko PMC), PA6638 (product of Seiko PMC), PA6640 (product of Seiko PMC), PA6644 (product of Seiko PMC), PA6646 (product of Seiko PMC), PA6654 (product of Seiko PMC), PA6702 (product of Seiko PMC), PA6704 (product of Seiko PMC) or CP8994 (product of Seiko PMC) can be mentioned and is not restricted, however, from the view point of color developing sensitivity, it is desirable to use polyamine resin.

Desirable containing ratio of epichlorohydrin resin and modified polyamino/amide resin to be used in the present invention is as follows, that is, respectively 1-100 weight parts to 100 weight parts of carboxy modified polyvinylalcohol, and more desirable containing ratio is 5-50 weight parts to 100 weight parts of carboxy modified polyvinylalcohol. When the containing amount is too small, crosslinking reaction is not sufficient and good water resistance can not be obtained and when the containing amount is too much, workability becomes worth because viscosity of a coating liquid increases and cause a problem of gelation.

Further, pH of a coating liquid for protecting layer is desirably to be 6.0 or more. In particular, since epichlorohydrin resin is an alkaline hardening type resin, adequate crosslinking reaction is carried out at this range. And, if pH is adjusted to lower range than this range, crosslinking reaction is disturbed.

For the purpose to improve a property of sticking resistance and ordinary printing aptitude such as offset printing, it is desirable to add a pigment in a protecting layer of the thermally sensitive recording medium of the present invention. As a pigment to be contained in the protecting layer, inorganic or organic filler such as silica, calcium carbonate, kaolin, calcined kaolin, diatomaceous earth, talk, titanium oxide or aluminum hydroxide can be mentioned and not restricted, however, aluminum hydroxide, kaolin or silica is preferably used. Especially, it is desirable to use kaolin whose aspect ratio is 20 or more, more desirably 30 or more. By using a pigment whose aspect ratio is 20 or more, coating ability of the thermally sensitive recording medium is improved. Therefore, since preserving sensitivity of image part and blank part are improved and can prevent deterioration of thermal conduction rate to a thermally sensitive recording layer by smaller coating amount, excellent color developing sensitivity and recorded image can be obtained. Further, by containing a pigment whose aspect ratio is 20 or more, smoothness and lustrous of surface of a coated layer can be improved. Therefore, aimed smoothness can be obtained by treatment with a low pressure super calendar, consequently, excellent color developing sensitivity and recorded image can be obtained. However, when aspect ratio is over than 100, since a protecting layer becomes dense, problems of ink fixing ability, ink drying ability and color developing sensitivity at ordinary printing process are caused. Accordingly, more desirable aspect ratio of kaolin to be contained in a thermally sensitive recording layer is 20-100 and furthermore desirably is 30-75. Further, when average diameter of a pigment whose aspect ratio is 30 or more, which is contained in a protecting layer, is longer than 4 μm, pigment is exposed on the surface of a coated layer, accordingly, problems, such as deterioration of surface smoothness, deterioration of quality of recorded image, deterioration of lustrous, deterioration of luster of printed part and increase of friction with a thermal head (head abrasion) are caused. Therefore, average diameter of a pigment whose aspect ratio is 30 or more to be contained in a protecting layer is desirably shorter than 4 μm. Furthermore, when oil absorbing amount of a pigment whose aspect ratio is 30 or more is 30-100 ml/100 g, ink fixing ability and printed part lustrous of ordinary printing method becomes better. When oil absorbing amount is smaller than 30 ml/100 g, ink fixing ability becomes a problem because an ink for ordinary printing is not easily absorbed, and when oil absorbing amount is larger than 100 ml/100 g, since an ink for ordinary printing is excessively absorbed, a thermally sensitive recording medium having excellent printed part lustrous can not de obtained. While, in the present invention, the term of “aspect ratio of a pigment” means numerical value calculated as follows. That is, powder is photographed by an electric microscope and 100 specimens of particle are picked up at random, and “diameter/thickness” of each 100 particles are calculated and averaged, therefore, larger aspect ratio means that the pigment has larger flatness.

As a desirable containing ratio of carboxy modified polyvinylalcohol to be used in the present invention is 10-500 weight parts to 100 weight parts of pigment and more desirable containing ratio is 20-250 weight parts to 100 weight parts of pigment. When the containing ratio is too small, problem of deterioration of printing aptitude by falling down of surface strength, while, when the containing ratio is too much, viscosity of a coating liquid becomes high and coating by high concentration becomes difficult. Further, when concentration of a coating liquid is dropped down, it is necessary to coat excess amount of coating to obtain same coating amount and is not desirable because load to drying process is increased.

Further, in a case to contain kaolin whose aspect ratio is 30 or more, it is desirable to be used alone for the purpose to display excellent effect based on its specific shape, however, it can be used together with other various pigments when containing ratio of an inorganic pigment whose aspect ratio is 30 or more is 50 weight parts or more, desirably 80 weight parts or more to 100 parts of the total blending part of pigment.

Containing of a carboxyl group containing resin in a thermally sensitive recording layer of the present invention is desirable, because adhering ability between a protecting layer and a thermally sensitive recording layer is improved and water resistance at a boundary part becomes better. The reason why can be conjectured as follows, that is, a carboxyl group containing resin contained in a thermally sensitive recording layer causes crosslinking reaction with epichlorohydrin resin and modified polyamino/amide resin contained in a protecting layer, accordingly, water resistance at a boundary part between a protecting layer and a thermally sensitive recording layer is improved, further, self adhering is caused. In particular, in a case, when carboxy modified polyvinylalcohol, which is hydrophilic compound, is used in a protecting layer and a thermally sensitive recording layer, remarkable effect can be recognized. It is desirable, that carboxy containing resin is contained 30 weight % or more to total amount of binder contained in a thermally sensitive recording layer.

Furthermore, it is desirable to contain epichlorohydrin resin in a thermally sensitive recording layer of the thermally sensitive recording medium of the present invention. By containing same epichlorohydrin resin contained in the protecting layer, adhesive property between the thermally sensitive recording layer and the protecting layer is improved and dipping water resistance is improved. Moreover, it is desirable to add 0.2-2.0 weight parts of epichlorohydrin resin to a thermally sensitive recording layer. When adding amount of the epichlorohydrin resin is too much, stability of a coating deteriorates.

Secondly, specific examples of various materials which are used in the present invention are shown as follows, however, a binder, a crosslinking agent and a pigment can be used not only in a protecting layer but also in any coated layers formed by occasional demands in the range not to disturb the desired effect to the above mentioned object.

As a binder used in the present invention, for example, full saponified polyvinyl alcohol having a degree of polymerization of 200 to 1,900, partially saponified polyvinyl alcohol, acetoacetyl polyvinyl alcohol, carboxy modified polyvinyl alcohol, amide modified polyvinyl alcohol, sulfonic acid modified polyvinyl alcohol, butyral modified polyvinyl alcohol, olefin modified polyvinyl alcohol, nitlile modified polyvinyl alcohol, pyrorridone modified polyvinyl alcohol, silicone modified polyvinyl alcohol, other modified polyvinyl alcohol, hydroxyethylcellulose, methylcellulose, ethylcellulose, carboxymethylcellulose, styrene-maleic anhydride copolymer, styrene-butadiene copolymer, cellulose derivative such as ethylcellulose or acetylcellulose, casein, gum arabic, starch oxide, eterficated starch, dialdehyde starch, esterficated starch, polyvinyl chloride, polyvinyl acetate, polyacrylamide, polyacrylate, polyvinyl butyral, polystyrol and a copolymer thereof, polyamide resin, silicon resin, petroleum resin, terpene resin, ketone resin and cumarone resin can be mentioned. Those high molecular weight substances can be used by dissolving in a solvent such as water, alcohol, ketones, esters or hydrocarbon, or emulsifying or dispersing as a paste in water or another medium, and can be used according to the desired quality.

As a crosslinking agent used in the present invention, for example, glyoxal, methylolmelamine, melamine formaldehyde resin, melamine urea resin, polyamine epichlorohydrin resin, polyamide epichlorohydrin resin, potassium peroxide, ammonium peroxide, sodium peroxide, iron (III) oxide, magnesium chloride, borax, boric acid, alum or ammonium chloride can be mentioned.

As a pigment used in the present invention, for example, inorganic or inorganic fillers such as silica, calcium carbonate, kaolin, calcined kaoline, diatomaceous earth, talk, titanium oxide or aluminum hydroxide can be mentioned. As a pigment to be used in a protecting layer, aluminum hydroxide or kaolin are desirable from view point of abrasion of a thermal head.

As a slipping agent used in the present invention, for example, metallic salt of fatty acid such as zinc stearate or calcium stearate, waxes or silicone resin can be mentioned.

And in the present invention, as an image stabilizer which displays oil resistance effect can be added in the range not disturb the desired effect to above mentioned object, for example, 4,4′-buthylidene (6-t-butyl-3-methylphenol), 2,2′-di-t-butyl-5,5′-dimethyl-4,4′-sulphonyldiphenol, 1,1,3-tris(2-methyl-4-hydroxy-5-cyclohexylphenyl)butane, 1,1,3-tris(2-methyl-4-hydroxy-5-t-butylphenyl)butane, 4-benzyloxi-4′-(2,3-epoxy-2-methylpropoxy)diphenylsulfone or others can be mentioned.

Still further, an benzophenon or triazol ultraviolet ray absorbing agent, a dispersing agent, a defoaming agent, antioxidant or a fluorescent dye or others can be used.

As an electron donating leuco dye used in the present invention, all compounds which are public known in the field of conventional pressure sensitive or thermally sensitive recording paper can be used and not restricted, however, triphenylmetane compounds, fluorane compounds, fluorene compounds or divinyl compounds are desirably used.

Specific example of leuco or pale colored dye (dye precursor) are shown as follows. These compounds can be used alone or can be used together with.

### <Triphenyl Methane Leuco Dye>

3,3′-bis(p-dimethylaminophenyl)-6-dimethylaminophthalide [another name; Crystal Violet Lacton],
3,3-bis(p-dimethylaminophenyl)phthalide [another name; Malachite Green Lactone]

### <Fluorane Leuco Dyes>

3-diethylamino-6-methylfluorane
3-diethylamino-6-methyl-7-anilinofluorane
3-diethylamino-6-methyl-7-(o,p-dimethylanilino)fluorane
3-diethylamino-6-methyl-7-chlorofluorane
3-diethylamino-6-methyl-7-(m-trifluoromethylanilino)fluorane
3-diethylamino-6-methyl-7-(o-chloroanilino)fluorane
3-diethylamino-6-methyl-7-(p-chloroanilino)fluorane
3-diethylamino-6-methyl-7-(o-fluoroanilino)fluorane
3-diethylamino-6-methyl-7-(m-methylanilino)fluorane
3-diethylamino-6-methyl-7-n-octylanilinofluorane
3-diethylamino-6-methyl-7-n-octylaminofluorane
3-diethylamino-6-methyl-7-benzylaminofluorane
3-diethylamino-6-methyl-7-dibenzylamonofluorane
3-diethylamino-6-chloro-7-methylfluorane
3-diethylamino-6-chloro-7-anilinofluorane
3-diethylamino-6-chloro-7-p-methylanilinofluorane
3-diethylamino-6-ethoxyethyl-7-anilinofluorane
3-diethylamino-7-methylfluorane
3-diethylamino-7-chlorofluorane
3-diethylamino-7-(m-trifluoromethylanilino)fluorane
3-diethylamino-7-(o-chloroanilino)fluorane
3-diethylamino-7-(p-chloroanilino)fluorane
3-diethylamino-7-(o-fluoroanilino)fluorane
3-diethylamino-benzo[a]fluorane
3-diethylamino-benzo[c]fluorane
3-dibutylamino-6-methyl-fluorane
3-dibutylamino-6-methyl-7-anilinofluorane
3-dibutylamino-6-methyl-7-(o,p-dimethylanilino)fluorane
3-dibutylamino-6-methyl-7-(o-chloroanilino)fluorane
3-dibutylamino-6-methyl-7-(p-chloroanilino)fluorane
3-dibutylamino-6-methyl-7-(o-fluoroanilino)fluorane
3-dibutylamino-6-methyl-7-(m-trifluoromethylanilino)fluorane
3-dibutylamino-6-methyl-chlorofluorane
3-dibutylamino-6-ethoxyethyl-7-anilinofluorane
3-dibutylamino-6-chloro-7-anilinofluorane
3-dibutylamino-6-methyl-7-p-methyl anilinofluorane
3-dibutylamino-7-(o-chloroanilino)fluorane
3-dibutylamino-7-(o-fluoroanilino)fluorane
3-di-n-pentylamino-6-methyl-7-anilinofluorane
3-di-n-pentylamino-6-methyl-7-(p-chloroanilino)fluorane
3-di-n-pentylamino-7-(m-trifluoromethylaniliono)fluorane
3-di-n-pentylamino-6-chloro-7-anilinofluorane
3-di-n-pentylamino-7-(p-chloroanilino)fluorane
3-pyrrolidino-6-methyl-7-anilinofluorane
3-piperidino-6-methyl-7-anilinofluorane
3-(N-methyl-N-propylamino)-6-methyl-7-anilinofluorane
3-(N-methyl-N-cyclohexylamino)-6-methyl-7-anilinofluorane
3-(N-ethyl-N-cyclohexylamino)-6-methyl-7-anilinofluorane
3-(N-ethyl-N-xylamino)-6-methyl-7-(p-chloroanilino)fluorane
3-(N-ethyl-p-toluidino)-6-methyl-7-anilinofluorane
3-(N-ethyl-N-isoamylamino)-6-methyl-7-anilinofluorane
3-(N-ethyl-N-isoamylamino)-6-chloro-7-anilinofluorane
3-(N-ethyl-N-tetrahydrofurfurylamino)-6-methyl-7-anilinofluorane
3-(N-ethyl-N-isobutylamino)-6-methyl-7-anilinofluorane
3-(N-ethyl-N-ethoxypropylamino)-6-methyl-7-anilinofluorane
3-cyclohexylamino-6-chlorofluorane
2-(4-oxahexyl)-3-dimethylamino-6-methyl-7-anilinofluorane
2-(4-oxahexyl)-3-diethylamino-6-methyl-7-anilinofluorane
2-(4-oxahexyl)-3-dipropylamino-6-methyl-7-anilinofluorane
2-methyl-6-p-(p-dimethylaminophenyl)aminoanilinofluorane
2-methoxy-6-p-(p-dimethylaminophenyl)aminoanilinofluorane
2-chloro-3-methyl-6-p-(p-phenylaminophenyl)aminoanilinofluorane
2-chloro-6-p-(p-dimethylaminophenyl)aminoanilinofluorane
2-nitro-6-p-(p-diethylaminophenyl)aminoanilinofluorane
2-amino-6-p-(p-diethylaminophenyl)aminoanilinofluorane
2-diethylamino-6-p-(p-diethylaminophenyl)aminoanilinofluorane
2-phenyl-6-methyl-6-p-(p-phenylaminophenyl)aminoanilinofluorane
2-benzyl-6-p-(p-phenylaminophenyl)aminoanilinofluorane
2-hydroxy-6-p-(p-phenylaminophenyl)aminoanilinofluorane
3-methyl-6-p-(p-dimethylaminophenyl)aminoanilinofluorane
3-diethylamino-6-p-(p-diethylaminophenyl)aminoanilinofluorane
3-diethylamino-6-p-(p-dibutylaminophenyl)aminoanilinofluorane
2,4-dimethyl-6-[(4-dimethylamino)anilino]-fluorane

### <Fluorene Leuco Dyes>

3,6,6′-tris(dimethylamino)spiro[fluorene-9,3′-phthalide]
3,6,6′-tris(diethylamino)spiro[fluorene-9,3′-phthalide]

### <Divinyl Leuco Dyes>

3,3-bis-[2-(p-dimethylaminophenyl)-2-(p-methoxyphenyl)ethenyl]-4,5,6,7-te trabromo phthalide
3,3-bis-[2-(p-dimethylaminophenyl)-2-(p-methoxyphenyl)ethenyl]-4,5,6,7-te trachloro phthalide
3,3-bis-[1,1-bis(4-pyrrolidinophenyl)ethylene-2-yl]-4,5,6,7-tetrabromophthal ide
3,3-bis-[1-(4-methoxyphenyl)-1-(4-pyrrolidinophenyl)ethylene-2-yl]-4,5,6,7-tetra chlorophthalide

### <Others>

3-(4-diethylamino-2-ethoxyphenyl)-3-(1-ethyl-2-methylindol-3-yl)-4-azaphthalide
3-(4-diethylamino-2-ethoxyphenyl)-3-(1-octyl-2-methylindol-3-yl)-4-azaphthalide
3-(4-cyclohexylethylamino-2-methoxyphenyl)-3-(1-ethyl-2-methylindol-3-yl)-4-azaphthalide
3,3-bis(1-ethyl-2-methylindol-3-yl)phthalide
3,6-bis(diethylamino)fluorane-γ-(3′-nitro)anilinolactam
3,6-bis(diethylamino)fluorane-γ-(4′-nitro)anilinolactam
1,1-bis-[2′,2′,2″,2″-tetrakis-(p-dimethylaminophenyl)-ethenyl]-2,2-dinitrilethane
1,1-bis-[2′,2′,2″,2″-tetrakis-(p-dimethylaminophenyl)-ethenyl]-2-β-naphthoyl ethane
1,1-bis-[2′,2′,2″,2″-tetrakis-(p-dimethylaminophenyl)-ethenyl]-2,2-diacetylethane
bis-[2,2,2′,2′-tetrakis-(p-dimethylaminophenyl)-ethenyl]-methylmalonic acid dimethyl ester.

As an electron accepting color developing agent used in the present invention, all public known color developing agents in conventional pressure sensitive or thermally sensitive recording paper fields can be used and not especially restricted, however, for example, inorganic acidic compound such as activated clay, attapulgite, colloidal silica or aluminum silicate,
4,4′-isopropylidenediphenol, 1,1-bis(4-hydroxyphenyl)cyclohexane,
2,2-bis(4-hydroxyphenyl)-4-methylpentane, 4,4′-dihydroxydiphenylsulfide, hydroquinonemonobenzylether, 4-hydroxybenzylbenzoate,
4,4′-dihydroxydiphenylsulfone, 2,4′-dihydroxydiphenylsulfone,
4-hydroxy-4′-isopropoxydiphenylsulfone,
4-hydroxy-4′-n-propoxydiphenylsulfone, bis(3-allyl-4-hydroxyphenyl)sulfone,
4-hydroxy-4′-methyldiphenylsulfone,
4-hydroxyphenyl-4′-benzyloxyphenylsulfone,
3,4-dihydroxyphenyl-4′-methylphenylsulfone, aminobenzenesulfoamide derivatives disclosed in JPH8-59603A publication,
bis(4-hydroxyphenylthioethoxy)methane,
1,5-di(4-hydroxyphenylthio)-3-oxapentane,
bis(p-hydroxyphenyl)butylacetate, bis(p-hydroxyphenyl)methylacetate,
1,1-bis(4-hydroxyphenyl)-1-phenylethane,
1,4-bis[α-methyl-α-(4′-hydroxyphenyl)ethyl]benzene,
1,3-bis[α-methyl-α-(4′-hydroxyphenyl)ethyl]benzene,
di(4-hydroxy-3-methylphenyl)sulfide, 2,2′-thiobis(3-tert-octylphenol), 2,2′-thiobis(4-tert-octylphenol),
   phenolic compound such as diphenylsulfone crosslinked compound disclosed in WO97/16420 International Publication, compound disclosed in WO02/081229 International Publication or JP2002-301873 A publication, thiourea compound such as N,N′-di-m-chlorophenylthiourea, thiourea compounds such as p-chlorobenzoic acid, stearyl gallate,
bis[4-(n-octyloxycabonylamino)zincsalicylate]di-hydrate, aromatic carboxylic acid such as 4-[2-(p-methoxyphenoxy)ethyloxy]salicylic acid, 4-[3-(p-tolylsulfonyl)propyloxy]salicylic acid or 5-[p-(2-p-p-methoxyphenoxyethoxycumyl)salicylic acid, and salt of these aromatic acids with polyvalent metal such as zinc, magnesium, aluminium, calcium, titanium, manganese, thin or nickel, antipyrine complex of zinc thiocyanate, complex zinc salt of terephthalaldehydic and other aromatic carboxylic acid can be mentioned. These color developing agents can be used alone or together with. Diphenylsulfone crosslinking compound disclosed in WO97/16420 International Publication can be purchased as D-90, which is a product of Nihon Soda. Further, the compound disclosed in WO02/081229 International Publication can be purchased as commodity name NKK-395, D-100 of Nihon Soda. Still further, it is possible to contain metal chelete color developing component such as higher fatty acid metal complex salt disclosed in JP H10-258577 A publication or divalent hydroxyl aromatic compounds.

As a sensitizer used in a thermally sensitive recording medium of the present invention, conventional public known sensitizer can be used. As the specific example of the sensitizer, fatty acid amide such as amidestearate, or amideparmitate, ethylenebisamide, montan wax, polyethylene wax,
1,2-di(3-methylphenoxy)ethane, p-benzylbiphenyl,
β-benzyloxy naphthalene,
4-biphenyl-p-tolylether,
m-terphenyl,
1,2-diphenoxyethane,
dibenzyloxalate,
di(p-chlorobenzyl)oxalate,
di(p-methylbenzyl)oxalate,
dibenzylterephthalate,
benzyl-p-benzyloxybenzoate,
di-p-tolylcarbonate,
phenyl-α-naphythylcarbonate,
1,4-diethoxynaphthalene,
phenyl-1-hydroxy-2-naphthoate,
o-xylene-bis-(phenylether),
4-(m-methylphenoxymethyl)biphenyl,
dibenzyl-4,4′-ethylenedioxy-bis-benzoate,
dibenzoyloxymethane,
1,2-di(3-methylphenoxy)ethylene,
bis[2-(4-methoxy-phenoxy)ethyl]ether,
   methyl-p-nitrobenzoate or phenyl-p-toluenesulfonate can be mentioned, however, not restricted to these compounds. These sensitizers can be used alone or can be used together with.

The kinds and amount of electron donating leuco dye, electron accepting color developing agent and other components which are used in the thermally sensitive recording medium of the present invention, are decided according to the required properties and recording aptitude and not restricted, however, in general, 0.5 to 10 parts of electron accepting color developing agent, 0.5 to 10 parts of sensitizer to 1 part of electron donating leuco dye are used.

Aimed thermal sensitive recording medium can be obtained by coating a coating liquid composed of above mentioned constitution on a substrate such as paper, recycled paper, film, plastic film, foamed plastic film or non-woven cloth. And a complex sheet prepared by combining these substrates can be used as a substrate.

Electron donating leuco dye, electron accepting color developing agent and materials to be added by occasional demands are ground by a grinding machine such as ball mill, attreitor or sand grinder or adequate emulsifying machine so as the particle size to become several micron or less, further, a binder and various additives are added according to the object, thus a coating liquid is prepared. Method for coating is not restricted, and conventional well-known techniques can be used, for example, an off machine coater with various coaters such as air knife coater, rod blade coater, vent blade coater, bevel blade coater, roll coater or curtain coater or an on machine coater can be voluntarily chosen and used. Coating amount of a thermally sensitive recording layer is not restricted, and in general, in the range of 2-12 g/m² by dry weight. Further, coating amount of a protecting layer provided on a thermally sensitive recording layer is not restricted, and in general, in the range of 1-5 g/m² by dry weight.

A thermally sensitive recording medium of the present invention can provide an undercoating layer composed of polymer containing filler under a thermally sensitive recording layer for the purpose to enhance the color developing sensitivity. Further, the thermally sensitive recording medium can provide a back coating layer on the opposite side of the substrate to which the thermally sensitive recording layer is provided, for the purpose to correct the curling of the sheet. Furthermore, various public known techniques in the field of the thermally sensitive recording medium can be added voluntarily, for example, to carry out a smoothness treatment such as a super calendar treatment after coating process of each layer.

### EXAMPLE

The thermally sensitive recording medium of the present invention will be illustrated by Examples. In the illustration, parts and % indicate weight parts and weight %. Each solutions, dispersions and coating liquids are prepared as follows.

### Example 1

Compound of following ratio is stirred and dispersed and a coating liquid for undercoating layer is prepared.

U solution (coating liquid for undercoating layer)

| | |
|---|---|
| Calcined kaolin(product of Engelhard, commodity name: | 100 parts |
| Ansilex 90) | |
| styrene•butadiene copolymer latex (solid part 48%) | 40 parts |
| 10% aqueous solution of full saponificated polyvinylalcohol | 30 parts |
| (product of Kuraray, commodity name: PVA117) | |
| water | 160 parts |

After applying the coating liquid for under coating layer on one surface of a substrate (paper of 60 g/m²), dried and a coating paper with under coating layer of dry coating amount of 10.0 g/m² is obtained.

Dispersion of color developing agent (A solution), dispersion of leuco
dye (B solution) and dispersion of sensitizer (C solution) of following
composition are ground separately by a sand grinder in wet condition
so as to the average particle size becomes 0.5 micron
A solution (dispersion of color developing agent)

| | | |
|---|---|---|
| 4-hydroxy-4′-isopropoxydiphenylsulfone | 6.0 | parts |
| 10% aqueous solution of polyvinyl alcohol | 18.8 | parts |
| water | 11.2 | parts |

B solution (dispersion of basic leuco dye)

| | | |
|---|---|---|
| 3-dibutylamino-6-methyl-7-anilinofluorane (ODB-2) | 3.0 | parts |
| 10% aqueous solution of polyvinyl alcohol | 6.9 | parts |
| Water | 3.9 | parts |

C solution (dispersion of sensitizer)

| | | |
|---|---|---|
| dibenzyl oxalate | 6.0 | parts |
| 10% aqueous solution of polyvinyl alcohol | 18.8 | parts |
| water | 11.2 | parts |

Then dispersions are mixed by following ratio and a coating liquid for a
thermally sensitive layer is obtained.

Coating liquid for a thermally sensitive layer

| | | |
|---|---|---|
| A solution (dispersion of color developing agent) | 36.0 | parts |
| B solution (leuco dye dispersion) | 13.8 | parts |
| C solution (dispersion of sensitizer) | 36.0 | parts |
| 10% aqueous solution of full saponificated polyvinylalcohol | 25 | parts |
| (product of Kuraray, commodity name: PVA117) | | |

After applying the coating liquid for thermally sensitive recording layer on an under coating layer of the under-coated paper, then dried and a coated paper with thermally sensitive layer of coating amount of 6.0 g/m² is obtained.

Then a coating liquid for a protecting layer is obtained by mixing by following ratio.

| | |
|---|---|
| 50% dispersion of aluminum hydroxide (product of | 9.0 parts |
| Martinsberg, aspect ratio: 5, average particle size; 3.5 μm, | |
| oil absorbing amount: 50 ml/100 g) | |
| 10% aqueous solution of carboxy modified polyvinylalcohol | 30 parts |
| (product of Kuraray, commodity name: | |
| KL118 <polymerization degree: 1700 around, saponification | |
| degree: 95-99 mol %, sodium acetate: 3% or less>) | |
| zinc stearate (product of Chukyo Yushi, commodity | 2.0 parts |
| name: Hydrine Z-7-30, solid part 30%) | |
| polyamide epichlorohydrine resin (product of SEIKO | 4.0 parts |
| PMC: commodity name: WS4020, solid part 25% <cationic | |
| degree: 2.7, molecular weight 2,200,000, quaternary | |
| amine>) modified polyamine resin (product of | |
| Sumitomo Chemical: Sumirez | |
| Resin SPI-102A, solid part 45%) | 2.2 parts |

Then, the coating liquid for a protecting layer is coated on a thermally sensitive recording layer of above mentioned paper for thermally sensitive recording layer coating so as the coating amount to be 3.0/m², dried and treated by a super calendar so as the smoothness to be 1000-2000 seconds, and a thermally sensitive recording medium is obtained.

### Example 2

A thermally sensitive recording medium is prepared by same method as Example 1 except changing carboxy modified polyvinylalcohol to be blended in a coating liquid for a protecting layer of Example 1 to other carboxy modified polyvinylalcohol (product of Kuraray, commodity name: KL318<polymerization degree: 1,700 around, saponification degree: 85-90 mol %, sodium acetate: 3% or less>)

### Example 3

A thermally sensitive recording medium is prepared by same method as Example 1 except changing carboxy modified polyvinylalcohol to be blended in a coating liquid for a protecting layer of Example 1 to other carboxy modified polyvinylalcohol (product of Nihon Gose Kagaku, commodity name: T350<polymerization degree: 1,700 around, saponification degree: 93-95 mol %, sodium acetate: 3% or less>).

### Example 4

A thermally sensitive recording medium is prepared by same method as Example 1 except changing 4.0 parts of polyamide epichlorohydrine resin to be blended in a coating liquid for a protecting layer of Example 1 to 5.0 parts of other polyamide epichlorohydrine resin (product of SEIKO PMC: commodity name: WS4010, solid part 20%<cationic degree: 3.9, molecular weight 800,000, quaternary amine>).

### Example 5

A thermally sensitive recording medium is prepared by same method as Example 1 except changing 4.0 parts of polyamide epichlorohydrine resin to be blended in a coating liquid for a protecting layer of Example 1 to 2.0 parts of other polyamide epichlorohydrine resin (product of SEIKO PMC: commodity name: SRD150, solid part 50%<cationic degree: 6.7, molecular weight 400,000, quaternary amine>).

### Example 6

A thermally sensitive recording medium is prepared by same method as Example 1 except changing 2.2 parts of modified polyamine resin to be blended in a coating liquid for a protecting layer of Example 1 to 1.7 parts of other modified polyamine resin (product of Sumitomo Kagaku: commodity name: Sumirez Resin SPI-106N, solid part 60%).

### Example 7

A thermally sensitive recording medium is prepared by same method as Example 1 except changing 2.2 parts of modified polyamine resin to be blended in a coating liquid for a protecting layer of Example 1 to 1.7 parts of other modified polyamine resin (product of SEIKO PMC: commodity name: PA6640, solid part 60%).

### Example 8

A thermally sensitive recording medium is prepared by same method as Example 1 except changing full saponificated polyvinylalcohol of a coating liquid for a thermally sensitive recording layer to 10% aqueous solution of carboxy modified polyvinylalcohol (product of Kuraray, commodity name: KL118<polymerization degree: 1,700 around, saponification degree: 95-99 mol %, sodium acetate: 3% or less>).

### Example 9

A thermally sensitive recording medium is prepared by same method as Example 1 except changing 9.0 parts of 50% dispersion of aluminum hydroxide to be blended in a coating liquid for a protecting layer of Example 1 to 9.1 parts of 50% dispersion of kaolin (commodity name Capim NP, product of RIO CAPIM, aspect ratio: 20, average particle size 2.2 μm, oil absorption amount: 45 ml/100 g).

### Example 10

A thermally sensitive recording medium is prepared by same method as Example 1 except changing 9.0 parts of 50% dispersion of aluminum hydroxide to be blended in a coating liquid for a protecting layer of Example 1 to 1.0 parts of 50% dispersion of kaolin (commodity name Contour 1500, product of IMERYS, aspect ratio: 60, average particle size 2.5 μm, oil absorption amount: 45 ml/100 g:).

### Example 11

A thermally sensitive recording medium is prepared by same method as Example 10 except changing full saponificated polyvinylalcohol of a coating liquid for a thermally sensitive recording layer to 10% aqueous solution of carboxy modified polyvinylalcohol (product of Kuraray, commodity name: KL118<polymerization degree: 1,700 around, saponification degree: 95-99 mol %, sodium acetate: 3% or less>) and adding 0.8 parts of polyamide epichlorohydrine resin (product of SEIKO PMC: commodity name:WS4020).

### Example 12

A thermally sensitive recording medium is prepared by same method as Example 1 except changing 2.2 parts of modified polyamine resin to be blended in a coating liquid for a protecting layer of Example 1 to 2.2 parts of modified imine resin (product of SEIKO PMC: commodity name: CPA8994, solid part 40%).

### Example 13

A thermally sensitive recording medium is prepared by same method as Example 10 except changing full saponificated polyvinylalcohol of a coating liquid for a thermally sensitive recording layer to 10% aqueous solution of carboxy modified polyvinylalcohol (product of Kuraray, commodity name: KL118<polymerization degree: 1,700 around, saponification degree: 95-99 mol %, sodium acetate: 3% or less>).

### Comparative Example 1

A thermally sensitive recording medium is prepared by same method as Example 1 except changing modified polyamine resin to be blended in a coating liquid for a protecting layer of Example 1 to full saponificated polyvinylalcohol (product of Kuraray, commodity name: PVA117<polymerization degree: 1,700 around, saponification degree: 98-99 mol %, sodium acetate: 1% or less>).

### Comparative Example 2

A thermally sensitive recording medium is prepared by same method as Example 1 except changing modified polyamine resin to be blended in a coating liquid for a protecting layer of Example 1 to partially saponificated polyvinylalcohol (product of Kuraray, commodity name: PVA217<polymerization degree: 1700 around, saponification degree: 87-89 mol %, sodium acetate: 1% or less>).

### Comparative Example 3

A thermally sensitive recording medium is prepared by same method as Example 1 except not blending polyamide epichlorohydrin resin to be blended in a coating liquid for a protecting layer of Example 1, and changing 2.2 parts of modified polyamine resin to 4.4 parts.

### Comparative Example 4

A thermally sensitive recording medium is prepared by same method as Example 1 except not blending modified polyamine resin to be blended in a coating liquid for a protecting layer of Example 1, and changing 4.0 parts of polyamide epichlorohydrin resin to 8.0 parts.

### Comparative Example 5

A thermally sensitive recording medium is prepared by same method as Example 1 except not blending polyamide epichlorohydrin resin and modified polyamine resin to be blended in a coating liquid for a protecting layer of Example 1, and blending 5.0 parts of 40% aqueous solution of grioxal in stead of the polyamide epichlorohydrin resin and modified polyamine resin.

### Comparative Example 6

A thermally sensitive recording medium is prepared by same method as Example 1 except not blending polyamide epichlorohydrin resin to be blended in a coating liquid for a protecting layer of Example 1, and blending 2.5 parts of 40% aqueous solution of grioxal in stead of the polyamide epichlorohydrin resin.

### Comparative Example 7

A thermally sensitive recording medium is prepared by same method as Example 1 except not blending modified polyamine resin to be blended in a coating liquid for a protecting layer of Example 1, and blending 2.5 parts of 40% aqueous solution of grioxal in stead of the modified polyamine resin.

### <Evaluation of Recording Sensitivity>

Printing test is carried out on the prepared thermally sensitive recording medium at an applied energy of 0.41 mJ/dot by using TH-PMD of Okura Denki, (printing tester for thermally sensitive recording paper, thermal head of Kyocera is attached). Density of the printed image is measured by a Macbeth Densitometer (RD-914, using an amber filter).

### <Evaluation of Water Resistance>

### (1) Blocking Test

10 μl of water is dropped on the recorded surface of a thermally sensitive recording medium after evaluation test of recording sensitivity, and is folded to two so as the recorded surface to be inside, 100 g/cm² weight is loaded on the recording medium and is left for 24 hours under environment of 40° C., 90% Rh. After that the recorded surface is opened and blocking test is carried out. Evaluation standard is indicated as follows.
◯: blocking is not observed, and removal of recorded layer is not observed
x: blocking is caused, recorded layer is partially removed and discrimination of recorded part is difficult

### (2) Wet Rubbing Test

50 μl of water is dropped on the recorded surface of a thermally sensitive recording medium after evaluation test of recording sensitivity, and the surface of recorded surface is rubbed strongly by a finger. Degree of water resistance is evaluated. Evaluation standard is indicated as follows.
◯: no slimy feeling, and removal of recorded layer is not observed
Δ: slightly slimy touch but removal of recorded layer is not observed
x: recorded layer is eluted, recorded layer is partially removed and discrimination of recorded part is difficult

### (3) Dipping Water Resistance Test

Thermally sensitive recording medium on which a pattern (No. 8 check) is printed using TH-PMD of Okura Denki (printing tester for thermally sensitive recording paper, thermal head of Kyocera is attached) is dipped in tap water (23° C.) for 48 hours and evaluated by following standard.
◯: remaining density of recorded part is over than 90%, water bubble is slightly observed between protecting layer and thermally sensitive recording layer but removal of protecting layer is not observed
Δ: remaining density of recorded part is over than 90%, water bubble is observed between protecting layer and thermally sensitive recording layer and protecting is partially removed
x: remaining density of recorded part is less than 90% and protecting layer is almost removed

### <Evaluation of Printing Run-Ability>

### (1). Head Debris Test

Printing test is carried out on the prepared thermally sensitive recording medium at applied energy of 0.41 mJ/dot by using TH-PMD of Okura Denki, (printing tester for thermally sensitive recording paper, thermal head of Kyocera is attached). Head debris adhering is evaluated by following standard.

◯: head debris is not observed

Δ: head debris is observed slightly

x: many head debris are clearly observed

### (2) Sticking Test

Printing test is carried out on the prepared thermally sensitive recording medium at applied energy of 0.41 mJ/dot at −10° C. temperature by using TH-PMD of Okura Denki, (printing tester for thermally sensitive recording paper, thermal head of Kyocera is attached). Sticking and noise at recording process are evaluated by following standard.

◯: sticking is not observed and no noise

Δ: sticking is observed slightly and no noise

x: sticking is observed frequently and noise is large

Peculiar points of a protecting layer and thermal sensitive recording layer of each Examples and Comparative Examples are listed in Table 1 and evaluation results by above mentioned evaluation items are summarized in Table 2.

In Tables, PVA means carboxy modified PVA and aluminum means aluminum hydroxide.

TABLE 1

| | | protecting layer | | | | | | |
|---|---|---|---|---|---|---|---|---|
| | | | crosslinking agent | | | | | |
| | | | (solid parts) | | | | | |
| | | | | modified | | | thermally sensitive | |
| | | | | polyamine/ | | | recording layer | |
| | | | epichlorohydrine | amide | | pigment/ | | epichlorohydrine |
| | | binder | resin | resin | glyoxal | aspect ratio | binder | resin |
| Example | 1 | PVA | 1 | 1 | — | aluminum 5 | f.s.PVA | no |
| | 2 | PVA | 1 | 1 | — | aluminum 5 | f.s.PVA | no |
| | 3 | PVA | 1 | 1 | — | aluminum 5 | f.s.PVA | no |
| | 4 | PVA | 1 | 1 | — | aluminum 5 | f.s.PVA | no |
| | 5 | PVA | 1 | 1 | — | aluminum 5 | f.s.PVA | no |
| | 6 | PVA | 1 | 1 | — | aluminum 5 | f.s.PVA | no |
| | 7 | PVA | 1 | 1 | — | aluminum 5 | f.s.PVA | no |
| | 8 | PVA | 1 | 1 | — | aluminum 5 | PVA | no |
| | 9 | PVA | 1 | 1 | — | kaolin 20 | f.s.PVA | no |
| | 10 | PVA | 1 | 1 | — | kaolin 60 | f.s.PVA | no |
| | 11 | PVA | 1 | 1 | — | kaolin 60 | PVA | yes |
| | 12 | PVA | 1 | 1 | — | aluminum 5 | f.s.PVA | no |
| | 13 | PVA | 1 | 1 | — | kaolin 60 | PVA | no |
| Comparative | 1 | f.s.PVA | 1 | 1 | — | aluminum 5 | f.s.PVA | no |
| Example | 2 | f.s.PVA | 1 | 1 | — | aluminum 5 | f.s.PVA | no |
| | 3 | PVA | 0 | 2 | — | aluminum 5 | f.s.PVA | no |
| | 4 | PVA | 2 | 0 | — | aluminum 5 | f.s.PVA | no |
| | 5 | PVA | 0 | 0 | 2 | aluminum 5 | f.s.PVA | no |
| | 6 | PVA | 0 | 1 | 1 | aluminum 5 | f.s.PVA | no |
| | 7 | PVA | 1 | 0 | 1 | aluminum 5 | f.s.PVA | no |

PVA: carboxy modified polyinylalcohol
aluminum: aluminum hydroxide
f.s.PVA: full saponificated polyinylalcohol

TABLE 2

| | quality of thermally sensitive recording medium | | | | | |
|---|---|---|---|---|---|---|
| | | | | | printing | |
| | color | water resistance | | | run-ability | |
| | developing | | wet | dip- | head | |
| | sensitivity | blocking | rubbing | ping | debris | sticking |
| Exmp. 1 | 1.47 | ◯ | ◯ | Δ | ◯ | ◯ |
| Exmp. 2 | 1.45 | ◯ | ◯ | Δ | ◯ | ◯ |
| Exmp. 3 | 1.44 | ◯ | ◯ | Δ | ◯ | ◯ |
| Exmp. 4 | 1.46 | ◯ | ◯ | Δ | ◯ | ◯ |
| Exmp. 5 | 1.44 | ◯ | Δ | Δ | ◯ | Δ |
| Exmp. 6 | 1.45 | ◯ | ◯ | Δ | ◯ | ◯ |
| Exmp. 7 | 1.47 | ◯ | ◯ | Δ | ◯ | ◯ |
| Exmp. 8 | 1.45 | ◯ | ◯ | ◯ | ◯ | ◯ |
| Exmp. 9 | 1.51 | ◯ | ◯ | Δ | ◯ | ◯ |
| Exmp. 10 | 1.60 | ◯ | ◯ | Δ | ◯ | ◯ |
| Exmp. 11 | 1.60 | ◯ | ◯ | ◯ | ◯ | ◯ |
| Exmp. 12 | 1.39 | ◯ | ◯ | Δ | ◯ | ◯ |
| Exmp. 13 | 1.59 | ◯ | ◯ | ◯ | ◯ | ◯ |
| Co. Ex. 1 | 1.39 | X | X | X | X | X |
| Co. Ex. 2 | 1.37 | X | X | X | X | X |
| Co. Ex. 3 | 1.43 | X | X | X | X | X |
| Co. Ex. 4 | 1.47 | X | Δ | X | Δ | Δ |
| Co. Ex. 5 | 1.45 | X | X | X | X | Δ |
| Co. Ex. 6 | 1.42 | X | X | X | X | Δ |
| Co. Ex. 7 | 1.44 | X | Δ | X | Δ | Δ |

### INDUSTRIAL APPLICABILITY

In the present invention, a thermally sensitive recording medium having excellent water resistance, printing run-ability (head debris, sticking) and sensitivity can be obtained by containing carboxyl group containing resin as a binder and by containing epichlorohydrin resin together with modified polyamine/amide resin as a crosslinking agent in a protecting layer. Especially, the thermally sensitive recording medium has sufficient water resistance to water such as rain or humid, when used in outside.

1. A thermally sensitive recording medium having a protecting layer on a thermally sensitive recording layer containing a colorless or pale colored electron donating leuco dye and electron accepting color developing agent, said thermally sensitive recording layer is formed on a substrate, and said protecting layer is comprising a resin that contains a carboxyl group, epichlorohydrin resin and modified polyamine/amide resin.

2. The thermally sensitive recording medium of claim 1, wherein the thermally sensitive recording layer contains a resin that contains a carboxyl group.

3. The thermally sensitive recording medium of claim 1, wherein the resin that contains a carboxyl group contained in the protecting layer is carboxy modified polyvinylalcohol.

4. The thermally sensitive recording medium according to claim 2, wherein the resin that contains a carboxyl group contained in the thermally sensitive recording layer is carboxy modified polyvinylalcohol.

5. The thermally sensitive recording medium according to claim 1, wherein said protecting layer contains kaolin and/or aluminum hydroxide.

6. The thermally sensitive recording medium of claim 5, wherein aspect ratio of kaolin contained in the protecting layer is 20 or more.

7. The thermally sensitive recording medium according to claim 1, wherein molecular weight of epichlorohydrin resin contained in the protecting layer is 500,000 or more and cationic degree of it is 5 meq/100 g or less.

8. The thermally sensitive recording medium according to claim 1, wherein modified polyamine/amide resin is polyalkylene polyamide resin and/or polyalkylene polyamine resin.

9. The thermally sensitive recording medium according to claim 1, wherein said thermally sensitive recording layer contains epichlorohydrin resin.
